(19) United States
(12) Patent Application Publication
(10) Pub. No.: US 2012/0038877 A1
(43) Pub. Date: Feb. 16, 2012

(54) Jewelry with integrated reading glass lenses

(76) Inventors: Jean Peplinski Burns, Apple Valley, MN (US); Jeffrey Allen Burns, Apple Valley, MN (US)

(21) Appl. No.: 12/806,298

(22) Filed: Aug. 10, 2010

(51) Int. Cl. G02C 11/02

(52) U.S. Cl. 351/51

(57) ABSTRACT

Reading glass lenses integrated into fashionable jewelry to be worn by a person with presbyopia. The jewelry has one or multiple lenses that the wearer can hold between their thumb and fore fingers and in front of their eyes to see or read more clearly. Having inconspicuous lenses integrated into a necklace, bracelet, earrings or other jewelry item gives the wearer a convenient way to quickly read without needing to find their traditional reading glasses.

### BACKGROUND

### Prior Art

U.S Patents

| Patent Number | Issue Date | Patentee |
|---|---|---|
| 5,559,566 | September 1996 | Hansman |
| 5,604,548 | February 1997 | Kanbar |
| 6,033,068 | March 2000 | Spilkin, et al. |
| 5,110,197 | May 1992 | Arad |
| 5,024,515 | June 1991 | Beckemeyer |
| D380483 | July 1997 | Lee |

The instant invention relates to eyeglasses and more particularly to reading glasses for aiding people with presbyopia which are hand-held in use.

Reading glasses that each contain a frame with 2 lenses, hand-held reading lenses, hand-held magnifiers, and ornamental eyeglass attachments have been provided in prior art. While these units may be suitable for the particular purpose to which they address, they would not be as suitable for the purposes of the present invention as heretofore described.

### SUMMARY OF THE INVENTION

Presbyopia is an age related condition that makes it difficult for people to see objects up close. This condition usually becomes noticeable in the early to mid-forties and is a natural part of the eye's aging process. Presbyopia is overcome by the use of corrective reading glasses and by other means including bifocal lenses, magnifiers, contact lenses and corrective eye surgery.

Various designs for reading glasses are known. Conventional reading glasses comprise plastic or glass corrective lenses secured within plastic, or metal rim-type eyeglass frames. The frames typically have a pair of ear retainers hingedly connected to either end, so that the reading glasses can be worn on the bridge of the nose and secured by the ears of the wearer. While such conventional designs for reading glasses work well when properly prescribed and worn, because reading glasses are used to supplement the use of distance vision glasses or contact lenses, they are often forgotten or left behind because they are inconvenient to carry.

While bifocals have been developed to address the problem of forgetting or leaving behind reading glasses, many people find bifocals disorienting, particularly when viewing at an angle where the reading portion of the lens meets the distance portion of the lens. Consequently, many people choose not to wear bifocals and instead keep a separate pair of reading glasses.

Magnifiers may also be used to address presbyopia but they have a field of view which is limited by the size of the magnifier and the distance held from the reading material. Their size and their long handles make them bulky and cumbersome to carry. Finally, as magnifiers do not provide binocular vision, a reader is sometimes required to close one eye in order to achieve viewing clarity.

Contact lenses and surgical techniques are also available to correct presbyopia. However, contact lenses have their drawbacks, as will be appreciated by people who have worn them.

As a result, situations often arise where reading glasses are required but are not readily at hand. Some examples of these frustrating situations include: being in a candlelit restaurant unable to make out the menu entrees; trying to read product labels at a grocery store; standing in front of the medicine cabinet unable to read prescription dosage instructions; locating a map in the glove compartment but unable to read the small print; searching for a number in the telephone book but unable to read the listings, etc. Thus, there is a need for increased availability of reading glasses so that they are readily available when and where they are required to provide short-term vision assistance for reading.

A primary object of the present invention will overcome the shortcomings of the prior art devices by providing hand-held reading glass lenses integrated into fashionable jewelry to be worn by a person with presbyopia. The jewelry will have one or multiple lenses that the wearer can hold between their thumb and fore finger and in front of their eyes to see or read more clearly. To observers the lenses look to be part of the jewelry and are therefore inconspicuous but always ready when needed. Having lenses integrated into a necklace, bracelet, earrings or other jewelry item gives the wearer a convenient way to quickly read without needing to find their traditional reading glasses. Further objects of the invention will appear as the description proceeds.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWING FIGURES

FIG. 1 is a front view showing the instant invention.

FIG. 2 is a front perspective view showing the instant invention being worn by a person.

FIG. 3 is a front perspective view of the instant invention being used by a person.

FIG. 4 is a front perspective view of the instant invention of a second embodiment being used by a person.

### DETAILED DESCRIPTION OF THE PREFERRED EMBODIMENTS

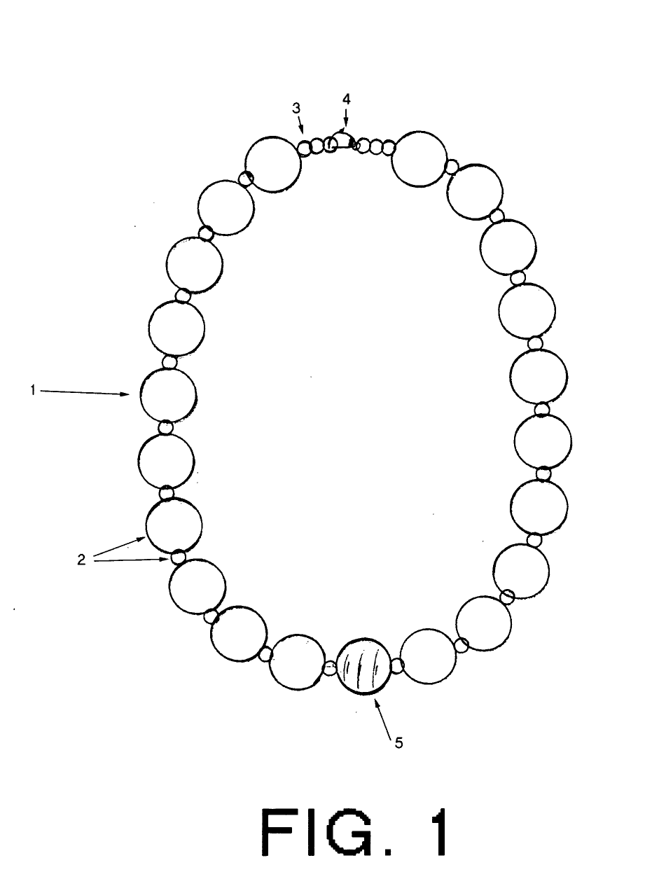

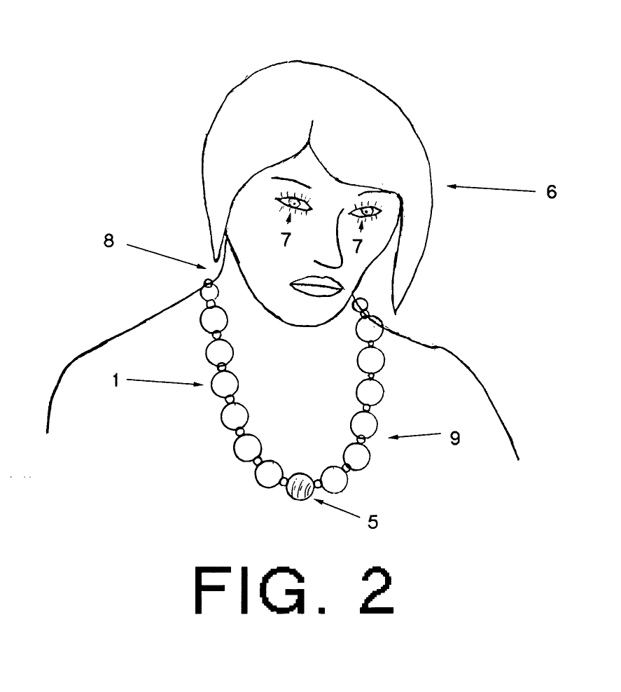

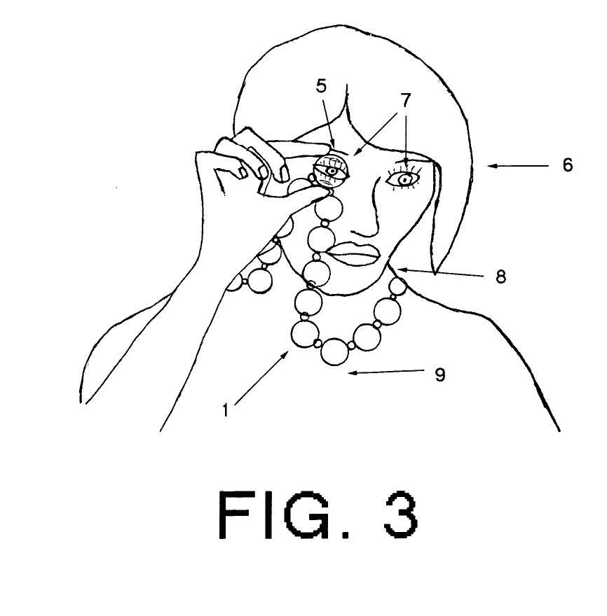

Turning now descriptively to the drawings, in which similar reference characters denote similar elements throughout the several views, FIGS. 1 through 3 illustrate a necklace with one integrated reading lens 1, comprising jump rings 2, chain 3, clasp 4, and a lens 5 fitted into the necklace and used for reading when placed in front of the eyes 7 of a person 6.

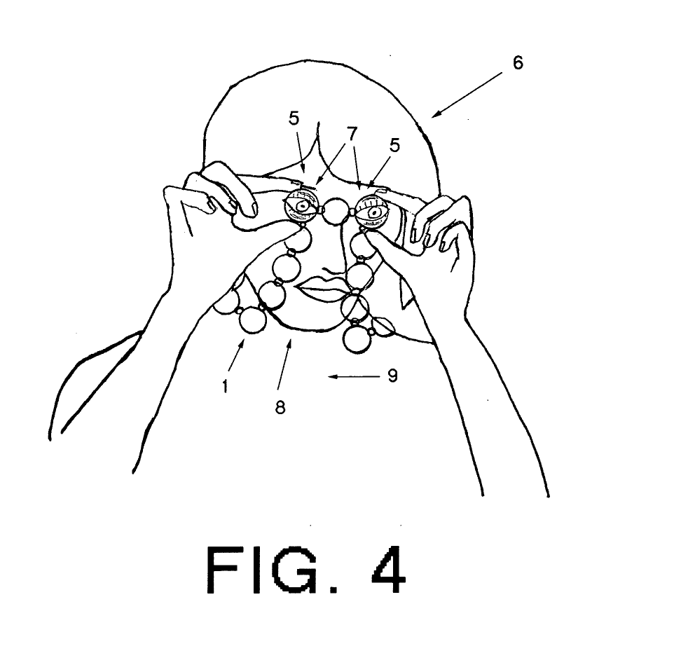

FIG. 4 illustrates another embodiment of necklace 1 with two integrated reading lenses.

### OPERATION OF THE INVENTION

To use the necklace with integrated reading lenses, the following steps should be taken:

1. Place the necklace 1 about the neck 8 of the person 6 and connect ends with clasp 4.

2. Let the necklace 1 hang down in front of the person 6 with the reading lens 5 at the bottom against the chest 9 of the person 6.

3. Using the thumb and forefinger lift the reading lens 5 and hold in front of the eye 7.

4. Look through the lens 5 to read.

5. Replace the necklace 1 about the chest 9 when finished reading.

### LIST OF REFERENCE NUMBERS

1 decorative necklace with integrated reading lens

2 jump rings

3 chain

4 clasp

5 reading glass lens

6 person

7 eyes of 6

8 neck of 6

9 chest of 6

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. Jewelry with integrated reading glass lenses:
a) a piece of jewelry consisting of standard jewelry components such as; findings, chain, jump rings, beads, wire, charms, or pendants that can be worn about the head, neck, wrists, ears or attached to clothing; and
b) one or more reading glass lenses fitted into said jewelry where jewelry components serve as rims or said lenses are rimless and affixed to said jewelry by other means.

2. The jewelry with integrated reading glass lenses of claim 1 wherein the said lenses are available with different diopter strengths.

3. The jewelry with integrated reading glass lenses of claim 1 wherein said jewelry components are different shapes, sizes, styles, colors and materials.

4. The jewelry with integrated reading glass lenses of claim 1 wherein said lenses are different sizes, shapes, colors and materials.

5. The jewelry with integrated reading glass lenses of claim 1 wherein the said lenses are removable.

6. The jewelry with integrated reading glass lenses of claim 1 wherein said jewelry contains a means of extending length in order to properly place said lenses in front of the eye.

7. The jewelry with integrated reading glass lenses of claim 1 wherein said jewelry contains a means of illumination.
